(19) United States
(12) Patent Application Publication
(10) Pub. No.: US 2010/0074618 A1
(43) Pub. Date: Mar. 25, 2010

(54) OPTICAL PATH SWITCHING DEVICE

(75) Inventors: Masayuki Togawa, Tokyo (JP); Junichiro Asano, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: NABTESCO CORPORATION, Minato-ku, Tokyo (JP)

(21) Appl. No.: 12/376,190

(22) PCT Filed: Aug. 3, 2006
(86) PCT No.: PCT/JP2006/315370

§ 371 Date: Oct. 14, 2009

(51) Int. Cl. H04J 14/00

(52) U.S. Cl. 398/45

(57) ABSTRACT

With the invention, it is possible to suppress losses of light for monitoring and enhances the optical confinement efficiency into an optical fiber for output over the related art. The optical path switching device 20 includes: a platform 22 housed in an enclosure 21 and mounting various types of optical components; optical fiber collimators 23, 24 as optical input means; an optical fiber collimator 25 as optical output means; a parallelogram prism 26 for switching over the optical path between the optical fiber collimators 23, 24 and 25 based on a change in its position; and light receiving elements 31, 32 for detecting a portion of the light inputted from the optical fiber collimators 23, 24 in order to monitor the light; and controls the position of the parallelogram prism 26 in accordance with the monitoring result of the light. The light receiving elements 31, 32 are arranged to detect only a portion of the light in the outer part in radial direction.

### TECHNICAL FIELD

The present invention relates to an optical path switching device which is used, for example, as an optical device in an optical communication system and which switches over the optical path.

### BACKGROUND ART

In the related art, an optical path switching device is known for switching over the optical path of a prism for optical switches by mechanically causing the prism to enter or exit from an optical path (move the prism between a position off the optical path and a position on the optical path), the optical path switching device designed to branch a portion of light at a predetermined ratio by way of an optical branching device and detect the branched light byway of a light receiving element (for example, refer to Patent Reference 1). The light quantity level of the light detected by the light receiving element is monitored by a light receiving circuit. The monitoring result may be used for the mechanical movement (entry/exit to/from an optical path) of the prism for optical switches. For example, in case the level of the received light detected by the light receiving element is below a predetermined level, a separately arranged controller drives means for moving a prism for optical switches. By moving the prism for optical switches from a position off the optical path to a position on the optical path, it is possible to switch over the optical path.

Patent Reference 1: JP-A-2003-21756 (FIG. 1, Page 5)

### DISCLOSURE OF THE INVENTION

### Problems that the Invention is to Solve

The related art optical path switching device uses a half mirror as an optical branching device for obtaining light for monitoring. The half mirror separates invading light into transmitted light and reflected light and guides the latter (reflected light) to a light receiving element and the former (transmitted light) to an optical fiber collimator for output. The light invading the optical fiber collimator for output is confined in an optical fiber while centered about the axial center of the luminous flux (portion with high quantity of concentrated light as viewed along the section of the light) by using condensing feature of the collimator lens. Note that the condensing performance of the collimator lens has certain limits. The half mirror as an optical branching device in a related art optical path switching device operates on all regions of the luminous flux to branches light. The half mirror also branches a portion of light near the axial center of the luminous flux, which invites losses of light. Thus, the related art optical path switching device does not have excellent optical confinement efficiency into an optical fiber for output.

The invention has been accomplished to solve the related art problems. An object of the invention is to provide an optical path switching device capable of enhancing optical confinement efficiency into an optical fiber for output over the related art.

### Means for Solving the Problems

The inventive optical path switching device comprises: at least one optical input means including an optical fiber and a lens for inputting an optical signal; at least one optical output means including an optical fiber and a lens for outputting an optical signal; an optical path switching component for switching over the optical path between the optical input means and the optical output means based on a change in its state; and an optical detection component for detecting a portion of the light inputted from the optical inputting means in order to monitor the light; the optical detection component controlled in accordance with the monitoring result of the light, characterized in that the optical detection component detects only a portion of the light in the outer part in radial direction.

With this configuration, an optical component detects only a portion of light inputted as an optical signal in the outer part in radial direction (that is, the light except near the axial center effective for confinement into the optical fiber). The optical path switching device of the invention suppresses losses of light for monitoring over the related art and enhances the optical confinement efficiency into an optical fiber for output over the related art.

The optical path switching device of the invention comprises optical branching means for branching only a portion of the light inputted from the optical input means in the outer part in radial direction and the optical detection component detects the light branched by this optical branching means.

With this configuration, the optical path switching device of the invention may reduce the restrictions on the mounting position of an optical detection component by appropriately setting the position and direction of the optical branching means, thus enhancing the freedom of design.

In the optical path switching device of the invention, the optical detection component is arranged in a position on which is directly incident only a portion of light inputted from the optical input means in the outer part in radial direction.

This configuration eliminates the optical branching means from the optical path switching device of the invention thus reducing the number of components.

### Advantage of the Invention

The invention provides an optical path switching device capable of enhancing optical confinement efficiency into an optical fiber for output over the related art.

### BRIEF DESCRIPTION OF THE DRAWINGS

FIG. 1 is a block diagram of an optical communication system according to a first embodiment of the invention.

FIG. 2 shows the side surface section of the optical communication system shown in FIG. 1.

FIG. 3A shows the top surface section of the optical path switching device shown in FIG. 2.

FIG. 3B shows the top surface section of the optical path switching device shown in FIG. 2 in a state different from that shown in FIG. 3A.

FIG. 4 is a top view of the reflecting mirror of the optical path switching device shown in FIG. 2.

FIG. 5 shows the side surface section of the optical communication system according to the first embodiment of the invention in a configuration different from that shown in FIG. 2.

FIG. 6A shows the top surface section of the optical path switching device of the optical communication system according to the second embodiment of the invention.

FIG. 6B shows the top surface section of the optical path switching device shown in FIG. 6A in a state different from that shown in FIG. 6A.

FIG. 7 is a top view of the glass block of the optical path switching device shown in FIGS. 6A and 6B.

FIG. 8 is a top view of the glass block of the optical path switching device of the optical communication system according to the second embodiment of the invention in a configuration different from that shown in FIG. 7.

FIG. 9A shows the top surface section of the optical path switching device of the optical communication system according to the third embodiment of the invention.

FIG. 9B shows the top surface section of the optical path switching device shown in FIG. 9A in a state different from that shown in FIG. 9A.

FIG. 10 is a top view of the reflecting mirror of the optical path switching device shown in FIG. 9.

FIG. 11A shows the top surface section of the optical path switching device of the optical communication system according to the fourth embodiment of the invention.

FIG. 11B shows the top surface section of the optical path switching device shown in FIG. 11A in a state different from that shown in FIG. 11A.

FIG. 12 is a top view of the reflecting mirror of the optical path switching device shown in FIGS. 11A and 11B.

FIG. 13 is a top view of a lens including a reflecting film formed thereon in place of the reflecting mirror shown in FIG. 12.

FIG. 14A shows the top surface section of the optical path switching device of the optical communication system according to the fifth embodiment of the invention.

FIG. 14B shows the top surface section of the optical path switching device shown in FIG. 14A in a state different from that shown in FIG. 14A.

FIG. 15A shows the top surface section of the optical path switching device of the optical communication system according to the sixth embodiment of the invention.

FIG. 15B shows the top surface section of the optical path switching device shown in FIG. 15A in a state different from that shown in FIG. 15A.

FIG. 16 is a top view of the prism of the optical path switching device shown in FIG. 15.

FIG. 17A shows the top surface section of the optical path switching device of the optical communication system according to the seventh embodiment of the invention.

FIG. 17B shows the top surface section of the optical path switching device shown in FIG. 17A in a state different from that shown in FIG. 17A.

FIG. 18 is a top view of the light receiving element of the optical path switching device shown in FIGS. 17A and 17B.

### DESCRIPTION OF REFERENCE NUMERALS AND SIGNS

20: Optical path switching device

26: Parallelogram prism (optical path switching component)

31, 32: Light receiving element (light detecting component)

40: Optical path switching device

60: Optical path switching device

80: Optical path switching device

180: Optical path switching device

200: Optical path switching device

220: Optical path switching device

240: Optical path switching device

280: Optical path switching device

### BEST MODE FOR CARRYING OUT THE INVENTION

Embodiments of the invention will be described referring to figures.

### First Embodiment

The configuration of an optical communication system according to the first embodiment will be described.

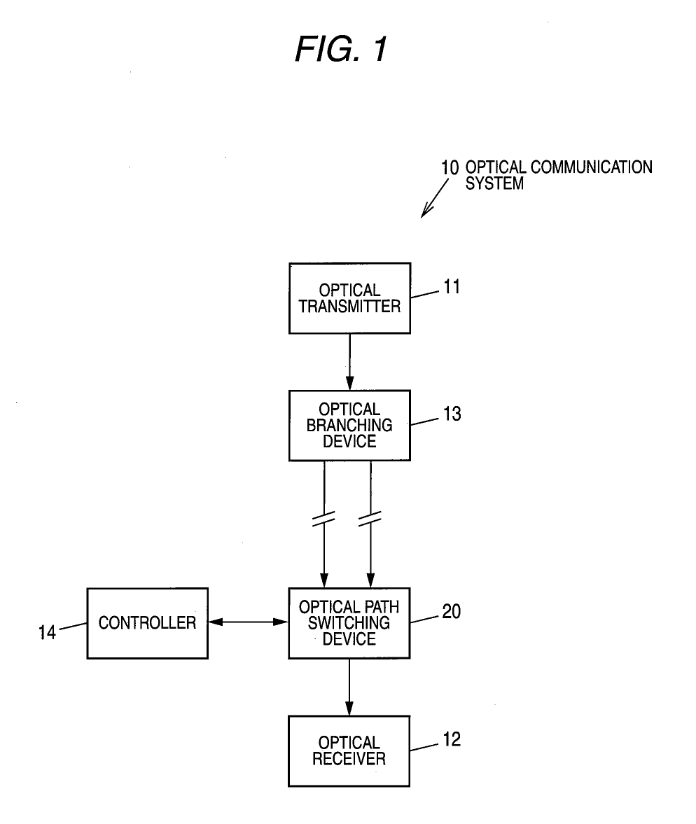

As shown in FIG. 1, an optical communication system 10 comprises: an optical transmitter 11 for transmitting an optical signal; an optical receiver 12 for receiving an optical signal; an optical branching device 13 for branching the optical signal transmitted by the optical transmitter 11 to two lines; a mechanism optical path switching device 20 for inputting an optical signal from each of the lines branched by the optical branching device 13 and outputting an optical signal received by the optical receiver 12; and a controller 14 for controlling the operation of the optical path switching device 20 so as to cause the optical receiver 12 to receive any one of the optical signals inputted from the two lines branched by the optical branching device 13.

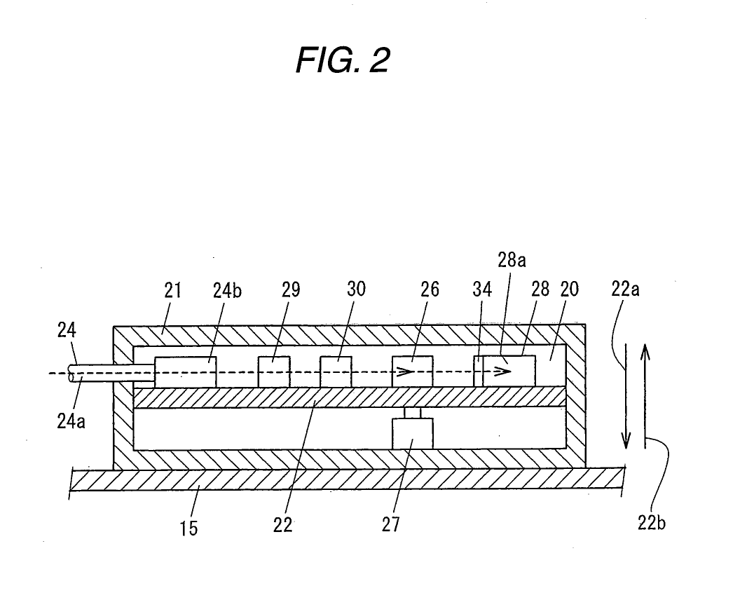

As shown in FIG. 2, the optical path switching device 20 is installed on the printed-circuit board 15 on which the controller 14 (refer to FIG. 1) is also installed. The optical path switching device 20 and the controller 14 are electrically connected to each other via a printed-circuit board 15.

As shown in FIGS. 2 3A and 3B, the optical path switching device 20 includes an enclosure 21 and a platform 22 housed in the enclosure 21 and mounting various types of optical components. The platform 22 mounts: an input optical fiber collimator 23 as optical input means for inputting an optical signal from one of the two lines branched by the optical branching device 13 (refer to FIG. 1); an input optical fiber collimator 24 as another optical input means for inputting an optical signal from the other of the two lines branched by the optical branching device 13; and an output optical fiber collimator 25 as optical output means for outputting an optical signal received by the optical receiver 12 (refer to FIG. 1). The optical path switching device 20 further includes a parallelogram prism as an optical path switching component for switching over the optical path based on a change in its position, that is, a change in its state in a direction orthogonal to the platform 22 shown by an arrow 22a (direction from the platform 22 to the printed-circuit board 15; hereinafter referred to as the downward direction) and a direction shown by an arrow 22b (direction from the platform 22 to the top surface of the enclosure 21; hereinafter referred to as the downward direction) opposite to the direction shown by the arrow 22a; an actuator 27 for moving the parallelogram prism 26 in vertical direction shown by the arrow 22a and the arrow 22b; a rectangular prism 28 for changing the direction of travel of light; reflecting mirrors 29, 30 for totally reflecting incident light; light receiving elements 31, 32 as an optical component for detecting light; and a light-absorbing bodies 33, 34 for absorbing light.

To the platform 22 are fixed optical fiber collimators 23 through 25, a rectangular prism 28, reflecting mirrors 29, 30, light receiving elements 31, 32, and the light-absorbing body 34. The light-absorbing body 33 is fixed to the parallelogram prism 26.

The optical fiber collimator 23 is composed of an optical fiber collimator 23a and a lens 23b. Similarly, the optical fiber collimator 24 is composed of an optical fiber collimator 24a and a lens 24b. Similarly, the optical fiber collimator 25 is composed of an optical fiber collimator 25a and a lens 25b.

The parallelogram prism 26 includes reflecting mirrors 26a, 26b in the form of a film mounted thereon for totally reflecting incident light. In case the reflecting surface is used under the total reflection condition, a reflecting film may be removed. Providing an anti-reflection film on the light incident surface enhances the transmission efficiency.

The rectangular prism 28 includes reflecting mirrors 28a, 28b in the form of a film mounted thereon for totally reflecting incident light. In case the reflecting surface is used under the total reflection condition, a reflecting film may be removed. Providing an anti-reflection film on the light incident surface enhances the transmission efficiency.

The light receiving elements 31, 32 are arranged in positions on the optical path to detect light upstream of the parallelogram prism 26 on the optical path.

The light receiving elements 31, 32 are designed to convert a detected optical signal to an electric signal and output the same to the controller 14 (refer to FIG. 1). The actuator 27 is designed to move the parallelogram prism 26 in accordance with a control signal received from the controller 14.

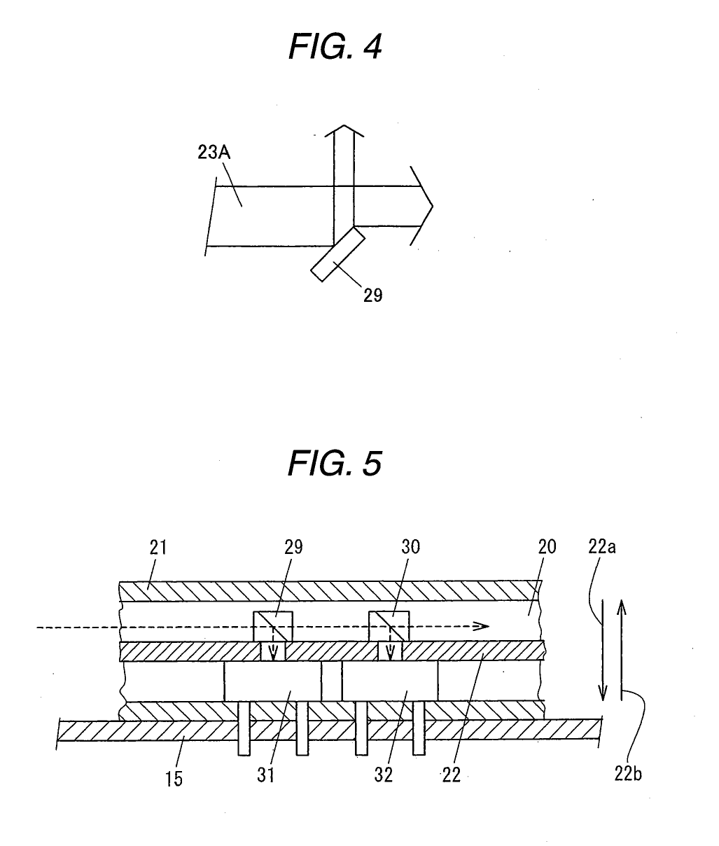

As shown in FIG. 4, the reflecting mirror 29 is arranged in a position on which is incident only a portion (hereinafter described as 5% as an example) of light 23A outputted from the optical fiber collimator 23 in the outer part in radial direction. The reflecting mirror 29 thus reflects and branches 5% of the light 23A outputted from the optical fiber collimator 23. Similarly, the reflecting mirror 30 is arranged at a position on which is incident only a portion (5%) of light outputted from the optical fiber collimator 24 in the outer part in radial direction. The reflecting mirror 30 thus reflects and branches 5% of the light outputted from the optical fiber collimator 24. The light branching ratio may be arbitrarily set depending on the position of a reflecting mirror in the radial direction of light. A branching ratio that may be set arbitrarily is generally specified within a practical range of 0.1 to 20%.

The operation of the optical communication system 10 will be described.

An optical signal transmitted by the transmitter 11 is branched to two lines by the optical branching device 13 and respective optical signals are inputted to the optical path switching device 20.

The optical path switching device 20 converts the quantity of light into respective electric signals and outputs the electric signals to the controller 14. The controller 14 determines whether any one of the two lines branched by the optical branching device 13 is faulty based on an electric signal inputted from the optical path switching device 20 and control the operation of the optical path switching device 20 so as to cause the optical receiver 12 to receive an optical signal inputted from an unaffected line.

The term “faulty” refers to a case where the actual light quantity level or wavelength is out of a predetermined value range. A light quantity level exceeding or below a predetermined light quantity level or a wavelength shorter than or longer than a predetermined wavelength corresponds to a fault. In order to check for such a fault, the optical path switching device 20 branches a portion of light with the reflecting mirrors 29, 30 and detects the branched light by way of the light receiving elements 31, 32 to perform monitoring of an optical signal.

The optical receiver 12 receives an optical signal passing through an unaffected line out of the lines between the optical branching device 13 and the optical path switching device 20.

The operation of the optical path switching device 20 will be described in detail. The controller 14 calculates the quantity of light emitted from the optical fiber collimator 23 based on an electric signal coming from the light receiving element 31. Assuming the ratio of quantity of light reflected by the reflecting mirror 29 to the quantity of light 23A outputted from the optical fiber collimator 23 (5% in the above example), the quantity of light received by the light receiving element 31, and the quantity of light emitted from the optical fiber collimator 23 respectively as R, p1 and P, P may be calculated using Expression 1.

P=p1/R [Expression 1]

When the quantity of light emitted from the optical fiber collimator 23 is within a predetermined range, the controller 14 determines that a line connected to the optical fiber collimator 23 is not faulty and transmits a control signal to the actuator 27 so as to place the parallelogram prism 26 on standby at the lower end of the travel range in the downward direction shown by the arrow 22a (position the parallelogram prism 26 has deviated from the optical path: position off the optical path). The actuator 27 thus places the parallelogram prism 26 on standby in a position off the optical path in accordance with a control signal coming from the controller 14.

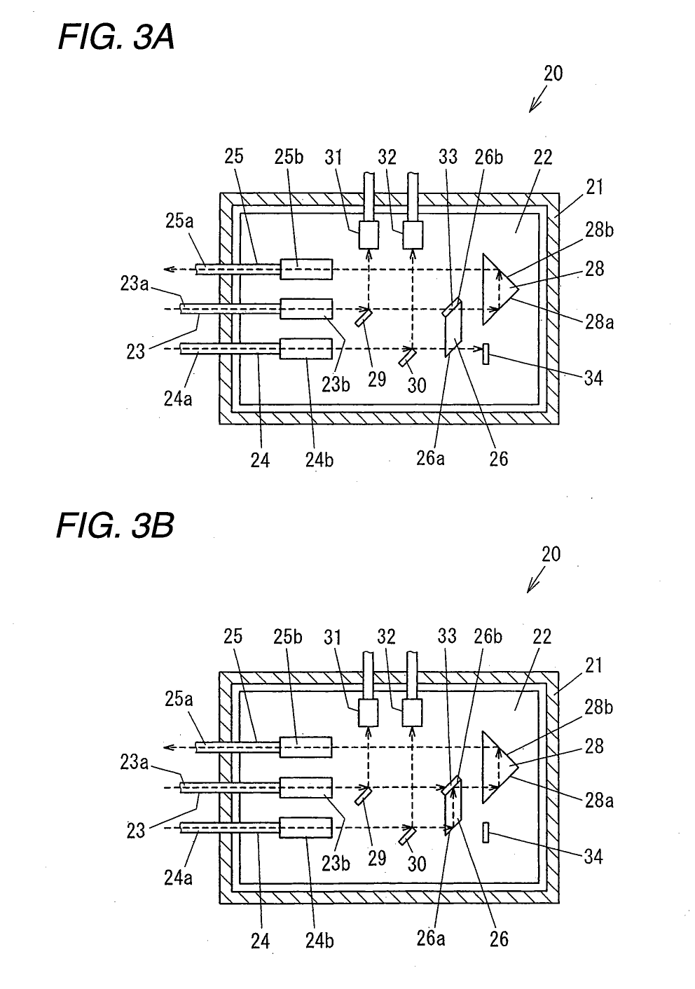

When the parallelogram prism 26 is in a position off the optical path, the light inside the optical path switching device 20 travels as shown by arrows in dotted lines in FIG. 3A. That is, of the light outputted from the optical fiber collimator 23, 5% is reflected by the reflecting mirror 29 and detected by the light receiving element 31 while 95% travels in the upward direction shown by the arrow 22b with respect to the parallelogram prism 26, is re-directed by the reflecting mirrors 28a, 28b of the rectangular prism 28, and is inputted to the optical fiber collimator 25. Of the light outputted from the optical fiber collimator 24, 5% is reflected by the reflecting mirror 30 and detected by the light receiving element 32 while 95% travels in the upward direction shown by the arrow 22b with respect to the parallelogram prism 26 and is absorbed by the light-absorbing body 34.

Thus, when the controller 14 has determined that a line connected to the optical fiber collimator 23 is not faulty, an optical signal that has passed through the line connected to the optical fiber collimator 23 is received by the optical receiver 12.

The wavelength of the light reflected on the mirror 29 may be the whole spectrum of the wavelength of the incident light or a portion thereof.

When the quantity of light emitted from the optical fiber collimator 23 is out of a predetermined range, the controller 14 determines that a line connected to the optical fiber collimator 23 is faulty and transmits a control signal to the actuator 27 so as to move the parallelogram prism 26 to the upper end of the travel range in the upward direction shown by the arrow 22b (position the parallelogram prism 26 intercepts the optical path: position on the optical path). The actuator 27 thus moves the parallelogram prism 26 to a position on the optical path in accordance with a control signal coming from the controller 14.

When the parallelogram prism 26 is in a position on the optical path, the light inside the optical path switching device 20 travels as shown by arrows in dotted lines in FIG. 3B. That is, of the light outputted from the optical fiber collimator 23, 5% is reflected by the reflecting mirror 29 and detected by the light receiving element 31 while 95% is absorbed by the light-absorbing body 33 fixed to the parallelogram prism 26. Of the light outputted from the optical fiber collimator 24, 5% is reflected by the reflecting mirror 30 and detected by the light receiving element 32 while 95% is re-directed by the reflecting mirrors 26a, 26b of the parallelogram prism 26 as well as the reflecting mirrors 28a, 28b of the rectangular prism 28, and is inputted to the optical fiber collimator 25.

Thus, when the controller 14 has determined that a line connected to the optical fiber collimator 23 is faulty, an optical signal that has passed through the line connected to the optical fiber collimator 24 is received by the optical receiver 12.

The controller 14 constantly monitors whether a line connected to the optical fiber collimator 24 is faulty based on an electric signal coming from the light receiving element 32.

Monitoring of the optical signal may be made on the quantity of light incident on a light receiving element as well As the wavelength, frequency, phase of light included in an optical signal or an encoded signal. That is, the controller 14 may transmit a control signal to the actuator 27 to switch over the optical path when detecting the predetermined wavelength of light or waveform itself (such as frequency, phase or encoded signal). For example, in a certain transmission system, when the transmission speed of an optical signal traveling from the optical transmitter 11 to the optical receiver 12 exceeds 10 Gbps, the wavelength of light, frequency or phase of the optical signal changes thus causing a line fault. In such a transmission system, all phenomena of malfunction may be determined as a line fault and an alternate optical path may be selected.

As described above, the optical path switching device 20 is designed to branch only a portion of light outputted from the optical fibers 23, 24 in the outer part in radial direction byway of the reflecting mirrors 29, 30 and detect the branched light with the light receiving elements 31, 32. This suppresses losses of light for monitoring and enhances the optical confinement efficiency into an optical fiber for output. The optical path switching device 20 arranges the light receiving elements 31, 32 in positions on the optical path to detect light upstream of the parallelogram prism 26 as an optical path switching component.

With the optical path switching device 20, the reflecting mirrors 29, 30 totally reflect incident light thus reducing the Polarization Dependent Loss (PDL). Moreover, general mirrors may be used as the reflecting mirrors 29, 30.

As shown in FIG. 5, the optical path switching device 20 may arrange the light receiving elements 31, 32 in the direction shown by the arrow 22a with respect to each of the reflecting mirrors 29, 30 and fix the reflecting mirrors 29, 30 diagonally with respect to the platform 22 so as to reflect a portion of light outputted from the optical fiber collimators 23, 24 in the direction shown by the arrow 22a toward each of the light receiving elements 31, 32. The configuration of the optical path switching device 20 shown in FIG. 5 may be of a more compact design than that shown in FIG. 3. In the configuration of the optical path switching device 20 shown in FIG. 5, the length of wiring from the light receiving elements 31, 32 to the printed-circuit board 15 is longer than that shown in FIG. 3. Thus, the configuration of the optical path switching device 20 shown in FIG. 5 is less vulnerable to disturbance noise even when only a faint signal is outputted from the light receiving elements 31, 32 than that shown in FIG. 3.

The optical path switching device 20 includes a member serving as the reference surface of each of the optical components such as the optical fiber collimators 23 through 25 and the parallelogram prism 26, that is, the platform 22 functioning as an optical flat. This provides the positioning accuracy of each optical component on the submicron order and maintains the position of each optical component despite a change in the ambient temperature of humidity.

### Second Embodiment

The configuration of an optical communication system according to the second embodiment will be described.

Part of the configuration of the optical communication system according to this embodiment similar to the configuration of the optical communication system 10 according to the first embodiment (refer to FIG. 1) will be given the same sign as that of the configuration of the optical communication system 10 and the corresponding details will be omitted.

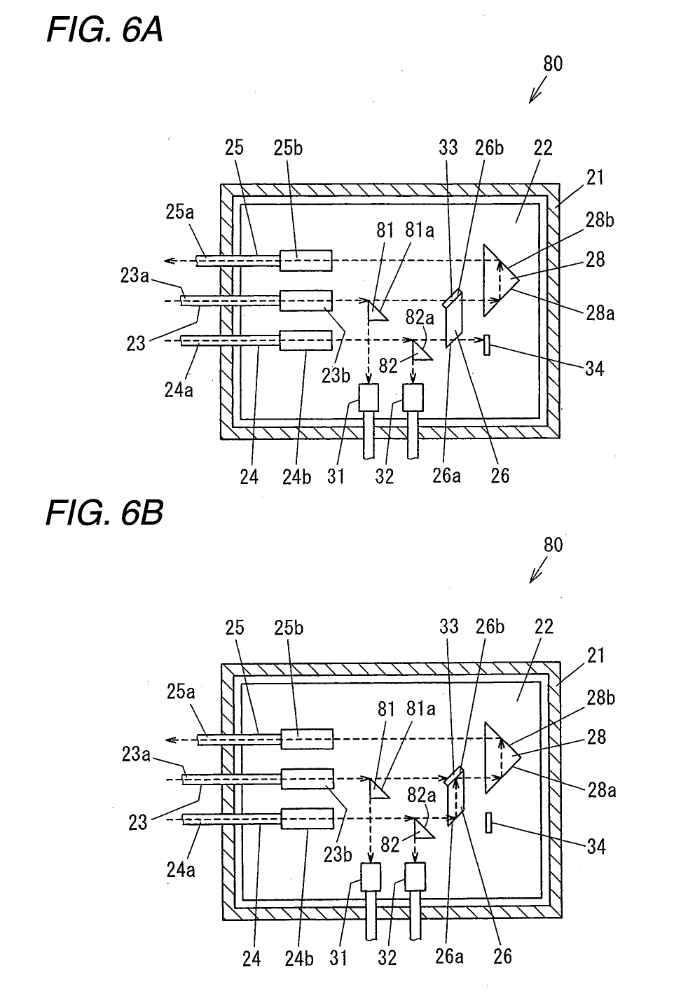

The configuration of the optical communication system according to this embodiment is similar to that of the optical communication system 10 except that a mechanical optical path switching device 80 shown in FIGS. 6A and 6B is used instead of the optical path switching device 20 (refer to FIG. 3).

The configuration of the optical path switching device 80 is similar to that of the optical path switching device 20 except that glass blocks 81, 82 including reflecting mirrors 81a, 82a for totally reflecting incident light are respectively formed of films is used instead of the reflective mirrors 29, 30 (refer to FIG. 3) and that the light receiving elements 31, 32 are fixed to different positions on the platform 22 from those in the optical path switching device 20.

The glass blocks 81, 82 are fixed to the platform 22.

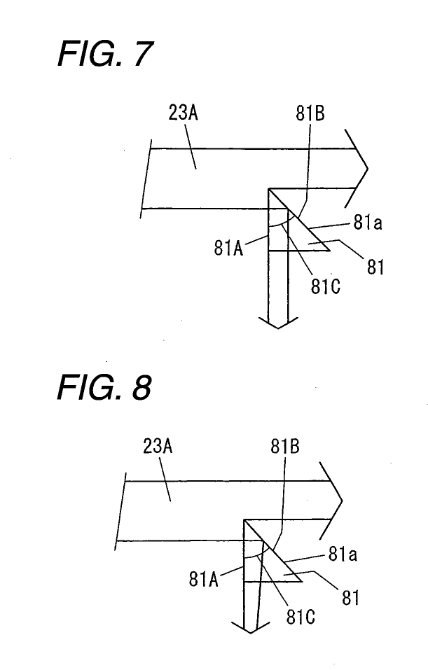

As shown in FIG. 7, the glass block 81 is arranged in a position on which is incident only a portion of light 23A outputted from the optical fiber collimator 23 on the outer periphery in radial direction so as to reflect a portion of light 23A outputted from the optical fiber collimator 23. The glass block 81 is arranged so that an angle 81C formed by the light incident surface 81A and the light reflecting surface 81B of the light 23A outputted from the optical fiber collimator 23 will be 45 degrees, for example, and that the light incident surface 81A will be nearly perpendicular to the travel direction of the light 23A. While description has been made on the glass block 81, the same is true to the glass block 82.

Next, the operation of the optical communication system according to this embodiment will be described.

The operation of the optical communication system according to this embodiment is almost similar to that of the optical communication system 10 according to the first embodiment (refer to FIG. 1) so that the corresponding details will be omitted.

When a controller 14 has determined that a line connected to the optical fiber collimator 23 is not faulty, light inside the optical path switching device 80 travels as shown by arrows in dotted lines in FIG. 6A. When the controller 14 has determined that a line connected to the optical fiber collimator 23 is faulty, the light inside the optical path switching device 80 travels as shown by arrows in dotted lines in FIG. 6B.

As described above, the optical path switching device 80 branches only a portion of light outputted from the optical fibers 23, 24 by way of the glass blocks 81, 82 in the outer part in radial direction and detects the branched light with the light receiving elements 31, 32. This suppresses losses of light for monitoring and enhances the optical confinement efficiency into an optical fiber for output.

In the optical path switching device 80, the glass block 81 is arranged so that the light incident surface 81A of the glass block 81 will be almost perpendicular to the travel direction of the light 23A outputted from the optical fiber collimator 23. It is thus possible to apply a low-cost antireflection film on the light incident surface 81A of the glass block 81. In the optical path switching device 80, the reflecting mirror 81a of the glass block 81 totally reflect incident light so that it is possible to form the reflecting mirror 81a with a general low-cost reflecting film. In case the refractivity of the glass block 81 is 1.5 and the light incident surface of light determined by the angle formed by the optical axis of the light and the light reflecting surface 81a exceeds 41.9 degrees, the total reflection condition is satisfied and a reflectivity of 100% is attained without using a reflecting film. The optical path switching device 80 includes the glass block 81 with a large installation area on the platform 22 instead of the thin reflecting mirror 29 (refer to FIGS. 3A and 3B) as in the optical path switching device 20 according to the first embodiment (refer to FIGS. 3A and 3B). This facilitates the work of fixing the reflecting mirror 81a to the platform 22 and reduces the workload of minute adjustment of the inclination of the reflecting mirror 81a with respect to the platform 22. The optical path switching device 80 includes the glass block 81 with a large installation area on the platform 22 instead of the thin reflecting mirror 29 as in the optical path switching device 20. This prevents possible inclination of the reflecting mirror 81a over time with respect to the platform 22 due to poor quality or degraded characteristic of an adhesive used for fixing thus maintaining the reliability of detection of an optical signal for a long period. While description has been made on the glass block 81, the same is true to the glass block 82.

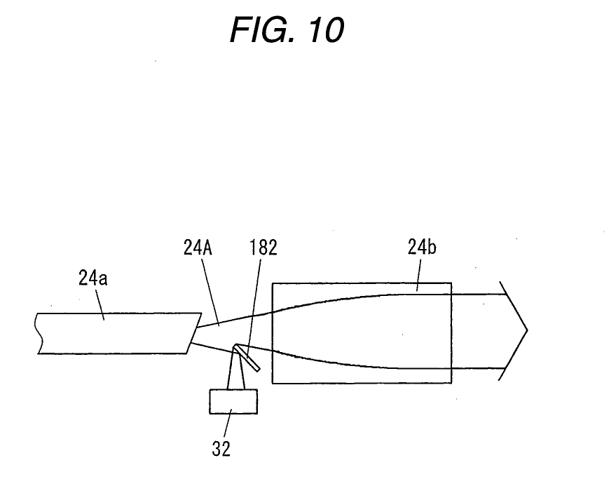

As shown in FIG. 10, the angle 81C of the glass block 81 may be less than 45 degrees. In case the angle 81C of the glass block 81 in the optical path switching device 80 is less than 45 degrees, the width of light received by the light receiving element 31 is narrowed to increase the intensity of light thus enhancing the light-receiving efficiency of the light receiving element 31. In case the angle 81C of the glass block 81 in the optical path switching device 80 is less than 45 degrees, the luminous flux of light received by the light receiving element 31 is narrowed thus reducing the light-receiving area of the light receiving element 31. As a result, a low-cost light receiving element 31 may be used or response of the light receiving element 31 to an optical signal is improved. Moreover, it is possible to reduce noise on an output signal from the light receiving element 31. While description has been made on the glass block 81, the same is true to the glass block 82.

### Third Embodiment

The configuration of an optical communication system according to the third embodiment will be described.

Part of the configuration of the optical communication system according to this embodiment similar to the configuration of the optical communication system 10 according to the first embodiment (refer to FIG. 1) will be given the same sign as that of the configuration of the optical communication system 10 and the corresponding details will be omitted.

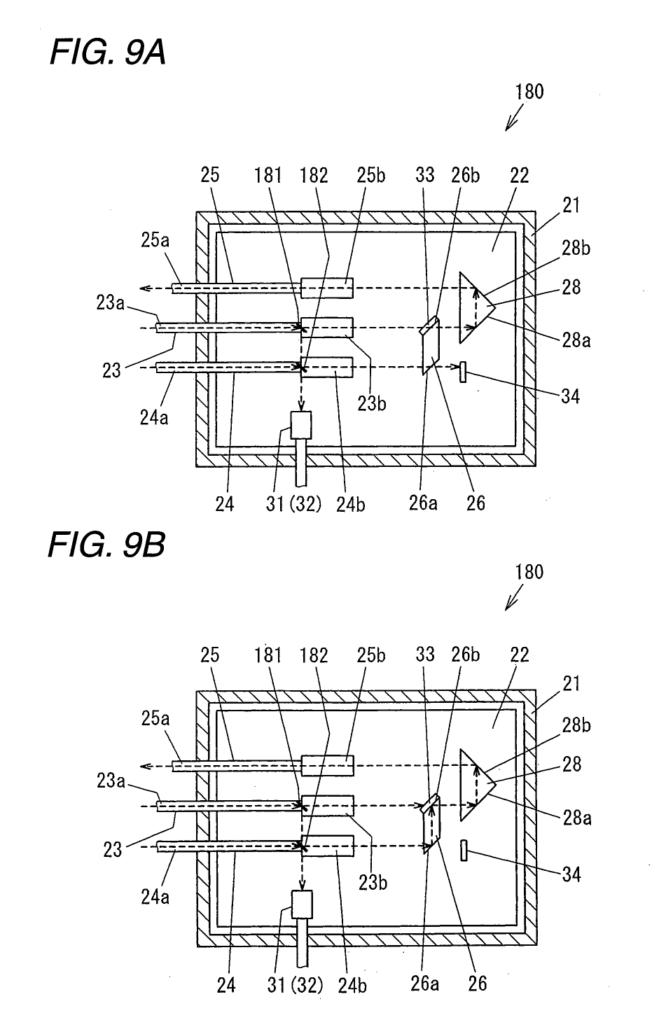

The configuration of the optical communication system according to this embodiment is similar to that of the optical communication system 10 except that a mechanical optical path switching device 180 shown in FIGS. 9A and 9B is used instead of the optical path switching device 20 (refer to FIG. 3).

The configuration of the optical path switching device 180 is similar to that of the optical path switching device 20 except that reflecting mirrors 181, 182 for totally reflecting incident light are used instead of the reflective mirrors 29, 30 (refer to FIGS. 3A and 3B) and that the light receiving elements 31, 32 are fixed to different positions from those in the optical path switching device 20.

The reflecting mirror 181 is inserted between an optical fiber 23a and a lens 23b and fixed to the platform 22. The reflecting mirror 182 is inserted between an optical fiber 24a and a lens 24b and fixed to the platform 22. The light receiving element 31 is fixed to an enclosure 21 in a position in a direction with respect to the light receiving element 32 shown by the arrow 22b (refer to FIG. 2). The light receiving element 32 is fixed to the platform 22. The reflecting mirror 181 is fixed diagonally to the platform 22 so as to allow reflected light to reach the light receiving element 31 without being obstructed by the optical fiber collimator 24.

As shown in FIG. 10, the reflecting mirror 182 is arranged in a position on which is incident only a portion (hereinafter described as 5% as an example) of light 24A outputted from the optical fiber 24a in the outer part in radial direction. The reflecting mirror 182 thus reflects 5% of the light 24A outputted from the optical fiber 24a. While description has been made on the reflecting mirror 182, the same is true to the reflecting mirror 181.

Next, the operation of the optical communication system according to this embodiment will be described.

The operation of the optical communication system according to this embodiment is almost similar to that of the optical communication system 10 according to the first embodiment (refer to FIG. 1) so that the corresponding details will be omitted.

When a controller 14 has determined that a line connected to an optical fiber collimator 23 is not faulty, light inside the optical path switching device 180 travels as shown by arrows in dotted lines in FIG. 9A. When the controller 14 has determined that a line connected to the optical fiber collimator 23 is faulty, the light inside the optical path switching device 180 travels as shown by arrows in dotted lines in FIG. 9B.

As described above, the optical path switching device 180 branches only a portion of light outputted from the optical fibers 23a, 24a by way of the reflecting mirrors 181, 182 in the outer part in radial direction and detects the branched light with the light receiving elements 31, 32. This suppresses losses of light for monitoring and enhances the optical confinement efficiency into an optical fiber for output.

The optical path switching device 180 includes the reflecting mirror 181 inserted between the optical fiber 23a and the lens 23b and the reflecting mirror 182 inserted between the optical fiber 24a and the lens 24b, thus providing a more compact design.

### Fourth Embodiment

The configuration of an optical communication system according to the fourth embodiment will be described.

Part of the configuration of the optical communication system according to this embodiment similar to the configuration of the optical communication system 10 according to the first embodiment (refer to FIG. 1) will be given the same sign as that of the configuration of the optical communication system 10 and the corresponding details will be omitted.

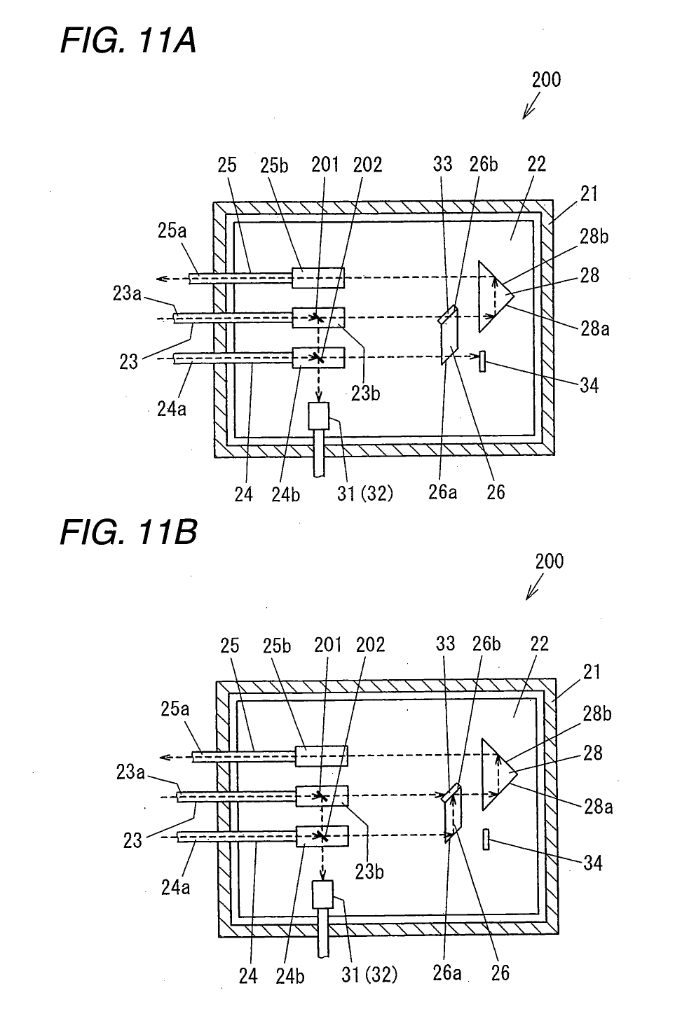

The configuration of the optical communication system according to this embodiment is similar to that of the optical communication system 10 except that a mechanical optical path switching device 200 shown in FIGS. 11A and 11B is used instead of the optical path switching device 20 (refer to FIGS. 3A and 3B).

The configuration of the optical path switching device 200 is similar to that of the optical path switching device except that reflecting mirrors 201, 202 for totally reflecting incident light are used instead of the reflective mirrors 29, 30 (refer to FIGS. 3A and 3B) and that the light receiving elements 31, 32 are fixed to different positions from those in the optical path switching device 20.

The reflecting mirrors 201, 202 are respectively fixed into lens 23b, 24b. The light receiving element 31 is fixed to an enclosure 21 in a position in a direction shown by an arrow 22b (refer to FIG. 2) with respect to the light receiving element 32. The light receiving element 32 is fixed to the platform 22. The reflecting mirror 201 is fixed diagonally to the lens 23b so as to allow reflected light to reach the light receiving element 31 without being obstructed by the optical fiber collimator 24.

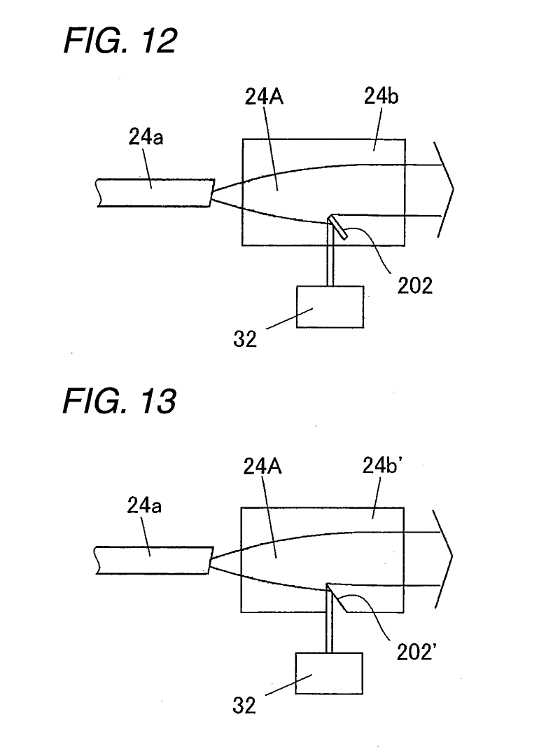

As shown in FIG. 12, the reflecting mirror 202 is arranged in a position on which is incident only a portion (hereinafter described as 5% as an example) of light 24A outputted from the optical fiber 24a in the outer part in radial direction. The reflecting mirror 202 thus reflects 5% of the light 24A outputted from the optical fiber 24a. While description has been made on the reflecting mirror 202, the same is true to the reflecting mirror 201. As an alternative to the reflecting mirror 202, a diagonal notch may be made in a lens 24b′ and a reflecting mirror may be formed on a slope 202′ formed thereon, as shown in FIG. 13.

Next, the operation of the optical communication system according to this embodiment will be described.

The operation of the optical communication system according to this embodiment is almost similar to that of the optical communication system 10 according to the first embodiment (refer to FIG. 1) so that the corresponding details will be omitted.

When a controller 14 has determined that a line connected to an optical fiber collimator 23 is not faulty, light inside the optical path switching device 200 travels as shown by arrows in dotted lines in FIG. 11A. When the controller 14 has determined that a line connected to the optical fiber collimator 23 is faulty, the light inside the optical path switching device 200 travels as shown by arrows in dotted lines in FIG. 11B.

As described above, the optical path switching device 200 branches only a portion of light outputted from the optical fibers 23, 24 by way of the reflecting mirrors 201, 202 in the outer part in radial direction and detects the branched light with the light receiving elements 31, 32. This suppresses losses of light for monitoring and enhances the optical confinement efficiency into an optical fiber for output.

The optical path switching device 200 includes the reflecting mirrors 201, 202 respectively fixed into the lenses 23b, 24b, and is thus easy to manufacture.

### Fifth Embodiment

The configuration of an optical communication system according to the fifth embodiment will be described.

Part of the configuration of the optical communication system according to this embodiment similar to the configuration of the optical communication system 10 according to the first embodiment (refer to FIG. 1) will be given the same sign as that of the configuration of the optical communication system 10 and the corresponding details will be omitted.

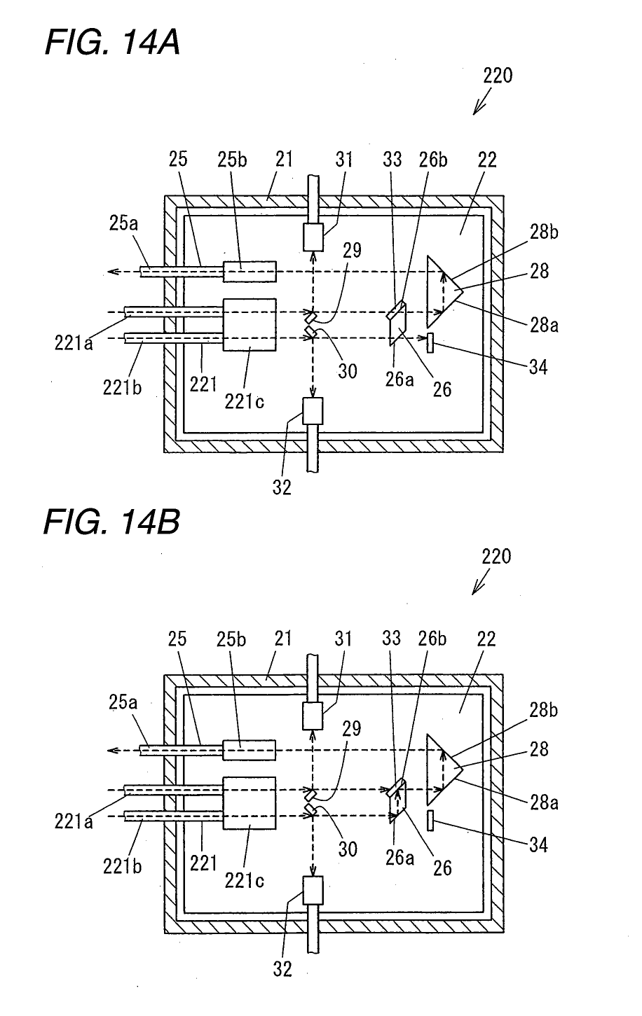

The configuration of the optical communication system according to this embodiment is similar to that of the optical communication system 10 except that a mechanical optical path switching device 220 shown in FIGS. 14A and 14B is used instead of the optical path switching device 20 (refer to FIGS. 3A and 3B).

The configuration of the optical path switching device 220 is similar to that of the optical path switching device 20 except that a single optical fiber collimator 221 to which an optical signal from one of the two lines branched by the optical branching device 13 (refer to FIG. 1) and an optical signal from the other of the two lines are inputted is used instead of the optical fiber collimators 23, 24 (refer to FIGS. 3A and 3B) and that a reflecting mirror 30 and a light receiving element 32 are fixed to different positions on the platform 22 from those in the optical path switching device 20.

The optical fiber collimator 221 is fixed to the platform 22.

The optical fiber collimator 221 is composed of an optical fiber 221a to which an optical signal from one of the two lines branched by the optical branching device 13 is inputted, an optical fiber 221b to which an optical signal from the other of the two lines branched by the optical branching device 13 is inputted, and a lens 221c.

Similar to the first embodiment, reflecting mirrors 29, 30 are arranged in a position on which is incident only a portion (hereinafter described as 5% as an example) of light outputted from the optical fiber collimator 221 in width direction. The reflecting mirrors 29, 30 thus reflect 5% of the light outputted from the optical fiber collimator 221.

Next, the operation of the optical communication system according to this embodiment will be described.

The operation of the optical communication system according to this embodiment is almost similar to that of the optical communication system 10 according to the first embodiment (refer to FIG. 1) so that the corresponding details will be omitted.

When a controller 14 has determined that a line connected to the optical fiber 221a is not faulty, light inside the optical path switching device 220 travels as shown by arrows in dotted lines in FIG. 14A. When the controller 14 has determined that a line connected to the optical fiber 221b is faulty, the light inside the optical path switching device 220 travels as shown by arrows in dotted lines in FIG. 14B.

As described above, the optical path switching device 220 branches only a portion of light outputted from the optical fibers 23, 24 by way of the reflecting mirrors 29, 30 in the outer part in radial direction and detects the branched light with the light receiving elements 31, 32. This suppresses losses of light for monitoring and enhances the optical confinement efficiency into an optical fiber for output.

The optical path switching device 220 includes a single optical fiber collimator 221 instead of two optical fiber collimators 23, 24 (refer to FIGS. 3A and 3B) as in the optical path switching device 20 according to the first embodiment (refer to FIGS. 3A and 3B). This reduces the number of processes of fixing optical components on the platform 22.

Similar to the optical path switching device 20 according to the first embodiment (refer to FIG. 5), the optical path switching device 220 may arrange the light receiving elements 31, 32 in downward direction shown by an arrow 22a (refer to FIG. 5) with respect to each of the reflecting mirrors 29, 30. The optical path switching device 220 may diagonally fix each of the reflecting mirrors 29, 30 to the platform 22 so as to reflect a portion of light outputted from the optical fiber collimator 221 in downward direction shown by the arrow 22a.

### Sixth Embodiment

The configuration of an optical communication system according to the sixth embodiment will be described.

Part of the configuration of the optical communication system according to this embodiment similar to the configuration of the optical communication system according to the fifth embodiment will be given the same sign as that of the configuration of the optical communication system according to the fifth embodiment and the corresponding details will be omitted.

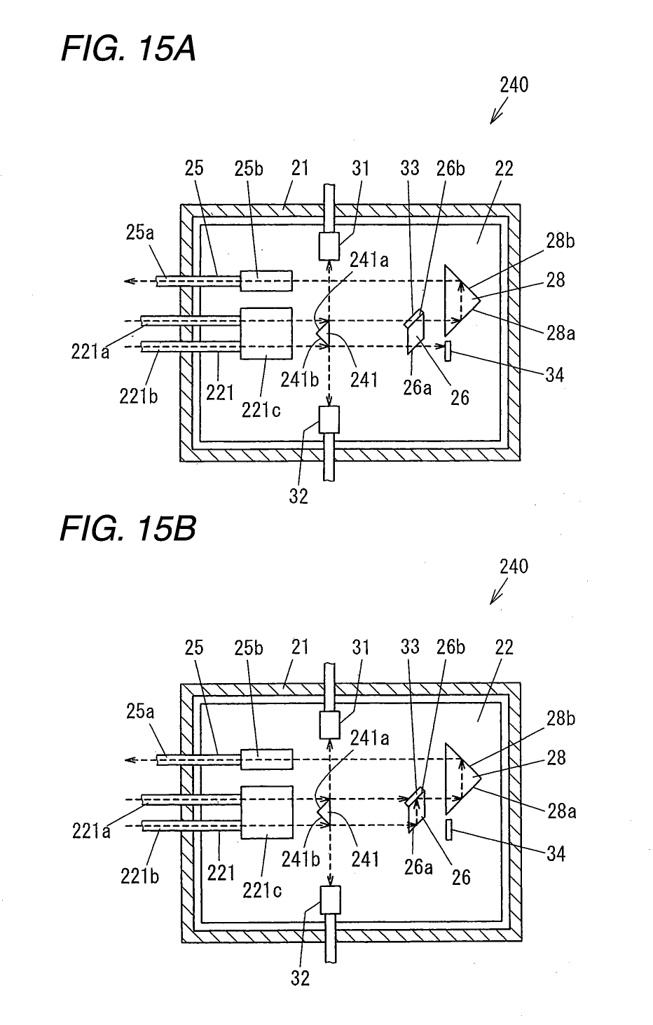

The configuration of the optical communication system according to this embodiment is similar to that of the optical communication system according to the fifth embodiment except that a mechanical optical path switching device 240 shown in FIGS. 15A and 15B is used instead of the optical path switching device 220 (refer to FIGS. 14A and 14B).

The configuration of the optical path switching device 240 is similar to that of the optical path switching device 220 except that a prism 241 including reflecting mirrors 241a, 241b for totally reflecting incident light formed by films is used instead of the reflective mirrors 29, 30 (refer to FIGS. 14A and 14B).

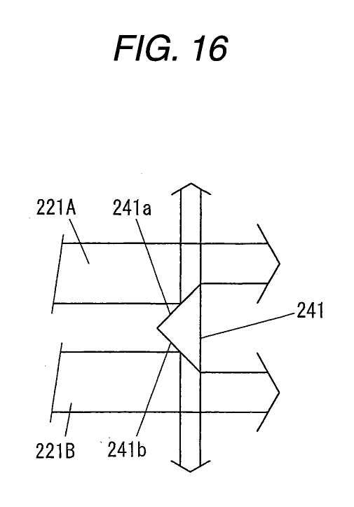

The prism 241 is fixed to a platform 22. As shown in FIG. 16, the prism 241 is arranged in a position on the reflecting mirror thereof is incident only a portion (hereinafter described as 5% as an example) of light 221A outputted from an optical fiber collimator 221 (refer to FIGS. 15A and 15B) via an optical fiber 221a (refer to FIGS. 15A and 15B) in the outer part in radial direction and on the reflecting mirror thereof is incident only a portion (hereinafter described as 5% as an example) of light 221B outputted from the optical fiber collimator 221 (refer to FIGS. 15A and 15B) via an optical fiber 221b (refer to FIGS. 15A and 15B) in width direction so as to reflect 5% of each light beam 221A, 221B outputted from the optical fiber collimator 221.

Next, the operation of the optical communication system according to this embodiment will be described.

The operation of the optical communication system according to this embodiment is almost similar to that of the optical communication system according to the 11th embodiment so that the corresponding details will be omitted.

When a controller 14 has determined that a line connected to an optical fiber 221a is not faulty, light inside the optical path switching device 240 travels as shown by arrows in dotted lines in FIG. 15A. When the controller 14 has determined that a line connected to the optical fiber 221b is faulty, the light inside the optical path switching device 240 travels as shown by arrows in dotted lines in FIG. 15B.

As described above, the optical path switching device 240 branches only a portion of light outputted from the optical fibers 221a, 221b by way of the reflecting mirrors 241a, 241b in the outer part in radial direction and detects the branched light with the light receiving elements 31, 32. This suppresses losses of light for monitoring and enhances the optical confinement efficiency into an optical fiber for output.

In the optical path switching device 240, both the optical fibers 221a, 221b are coupled to the lens 221c and the spacing between the optical fiber 221a and the optical fiber 221b is constant. This makes it easy to fix the optical fiber collimator 221 and the prism 241 to the platform 22 so as to satisfy the alignment therebetween shown in FIG. 21.

The prism 241 may be of a size to allow light outputted from the optical fiber collimator 221 to be totally incident on the reflecting mirrors 241a, 241b as long as the reflecting mirrors 241a, 241b are half mirrors that reflects a portion (for example 5%) of incident light and transmits the residual portion of the light.

### Seven Embodiment

The configuration of an optical communication system according to the seventh embodiment will be described.

Part of the configuration of the optical communication system according to this embodiment similar to the configuration of the optical communication system 10 according to the first embodiment (refer to FIG. 1) will be given the same sign as that of the configuration of the optical communication system 10 and the corresponding details will be omitted.

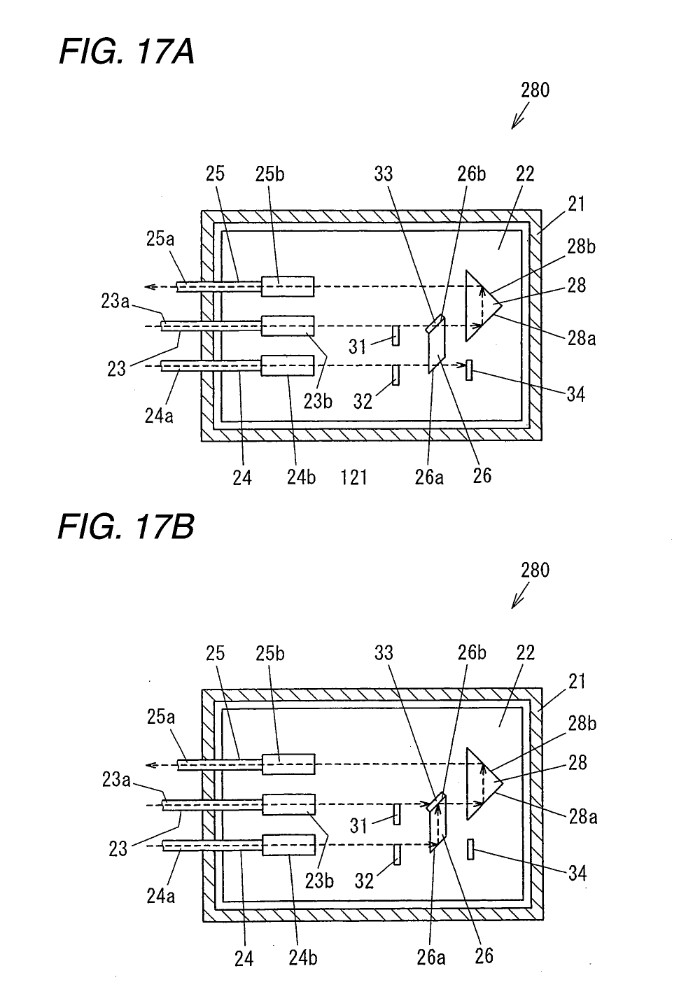

The configuration of the optical communication system according to this embodiment is similar to that of the optical communication system 10 except that a mechanical optical path switching device 280 shown in FIGS. 17A and 17B is used instead of the optical path switching device 20 (refer to FIGS. 3A and 3B).

The configuration of the optical path switching device 280 is similar to that of the optical path switching device 20 except that the reflecting mirrors 29, 30 (refer to FIGS. 3A and 3B) are removed and that light receiving elements 31, 32 are fixed to different positions on the platform 22 from those in the optical path switching device 20.

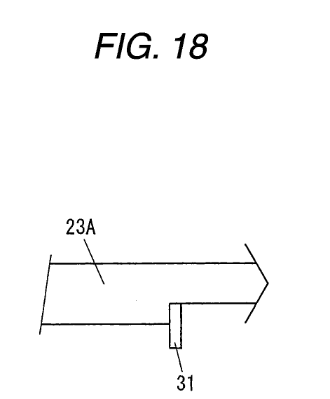

As shown in FIG. 18, the light receiving element 31 is arranged in a position on which is incident only a portion (hereinafter described as 5% as an example) of light 23A outputted from an optical fiber collimator 23 in the outer part in radial direction so as to receive 5% of light outputted from the optical fiber collimator 23. Similarly, the light receiving element 32 is arranged in a position on which is incident only a portion (hereinafter described as 5% as an example) of light outputted from an optical fiber collimator 24 in width direction so as to receive 5% of light outputted from the optical fiber collimator 24.

Next, the operation of the optical communication system according to this embodiment will be described.

The operation of the optical communication system according to this embodiment is almost similar to that of the optical communication system 10 according to the first embodiment (refer to FIG. 1) so that the corresponding details will be omitted.

When a controller 14 has determined that a line connected to the optical fiber collimator 23 is not faulty, light inside the optical path switching device 280 travels as shown by arrows in dotted lines in FIG. 17A. When the controller 14 has determined that a line connected to the optical fiber collimator 23 is faulty, the light inside the optical path switching device 280 travels as shown by arrows in dotted lines in FIG. 17B.

As described above, in the optical path switching device 280, the light receiving elements 31, 32 directly detect only a portion of light outputted from the optical fibers 2323a, 24a in the outer part in radial direction. This suppresses losses of light for monitoring and enhances the optical confinement efficiency into an optical fiber for output.

The optical path switching device 280 need not include the reflecting mirrors 29, 30 (refer to FIGS. 3A and 3B) unlike the optical path switching device 20 according to the first embodiment (refer to FIGS. 3A and 3B). The optical path switching device 280 thus uses a smaller number of components than the optical path switching device 20 and offers a more compact design.

The optical path switching device 280 directly receives optical signals outputted from the optical fiber collimator 23, 24 respectively by way of the light receiving elements 31, 32 thus reducing the Polarization Dependent Loss (PDL).

### INDUSTRIAL APPLICABILITY

As described above, the optical path switching device of the invention has advantages of suppressing losses of light for monitoring and enhancing the optical confinement efficiency into an optical fiber for output and is useful as an optical path switching device for optical communications.

FIG. 1
10: OPTICAL COMMUNICATION SYSTEM
11: OPTICAL TRANSMITTER
12: OPTICAL RECEIVER
13: OPTICAL BRANCHING DEVICE
14: CONTROLLER
20: OPTICAL PATH SWITCHING DEVICE

1. An optical path switching device comprising: at least one optical input means including an optical fiber and a lens for inputting an optical signal; at least one optical output means including an optical fiber and a lens for outputting an optical signal; an optical path switching component for switching over the optical path between the optical input means and the optical output means based on a change in its state; and an optical detection component for detecting a portion of said light inputted from said optical inputting means in order to monitor said light; said optical detection component controlled in accordance with the monitoring result of said light, characterized in that said optical detection component detects only a portion of said light in the outer part in radial direction.

2. The optical path switching device according to claim 1, further comprising optical branching means for branching only a portion of said light inputted from said optical input means in the outer part in radial direction, characterized in that said optical detection component detects the light branched by this optical branching means.

3. The optical path switching device according to claim 1, characterized in that said optical detection component is arranged in a position on which is directly incident only a portion of light inputted from said optical input means in the outer part in radial direction.
